(19) United States
(12) Patent Application Publication
(10) Pub. No.: US 2013/0218503 A1
(43) Pub. Date: Aug. 22, 2013

(54) CORIOLIS MASS FLOW METER AND SIGNAL PROCESSING METHOD FOR A CORIOLIS MASS FLOW METER

(71) Applicant: ABB Technology AG, (US)

(72) Inventor: Frank DRAUTZ, Freising (DE)

(73) Assignee: ABB Technology AG, Zurich (CH)

(21) Appl. No.: 13/768,262

(22) Filed: Feb. 15, 2013

(30) Foreign Application Priority Data
Feb. 18, 2012 (EP) 12 001 081.4
Aug. 22, 2012 (EP) 12 005 985.2

(51) Int. Cl. G01F 1/84

(52) U.S. Cl. CPC G01F 1/84
USPC 702/100

(57) ABSTRACT

Signal processing is disclosed for a Coriolis mass flow meter with one or more measuring tubes and meter electronics, which includes determining relevant modal properties of the flow meter during a measurement process, and adaptively correcting a current measurement result with the relevant modal properties of the flow meter obtained during the measurement process.

### RELATED APPLICATION(S)

This application claims priority under 35 U.S.C. §119 to European Patent Application No. 12001081.4 filed in Europe on Feb. 18, 2012, and European Patent Application No. 12005985.2 filed in Europe on Aug. 22, 2012, the entire contents of which are incorporated herein in their entirety.

### FIELD

The disclosure relates to a signal processing method for a Coriolis mass flow meter (a “CMF”) with one or more measuring tubes and with meter electronics.

### BACKGROUND INFORMATION

CMFs are capable of measuring mass flow rate, for example, the volume flow rate calculated with media density measured with the same device with accuracy and independent of most media properties. The measurement of mass flow rate is independent of most media properties because the measurement effect is directly proportional to the desired measurement value.

However, the Coriolis measurement principle can impose some restrictions for the functionality of such a device. As the complete mechanical system of the sensor of a CMF includes the medium of which the mass flow is to be measured, and is also affected by the environment, for example, the mounting conditions, environmental conditions, etc., the dynamic response of the complete mechanical sensor system can be different, for example, for two media with different density or viscosity, as these properties will change mass inertia or dissipation properties of the sensor, or at different temperatures, which may affect Young's modulus of the materials or lead to thermal induced stress.

The described effects can be reflected inevitably in the measured values and therefore reduce the accuracy of the CMF.

In Coriolis flow measurement technology, a CMF can be designed such that the described effects can have a minor impact on this functionality. However, this may result in the design and construction of the CMF with resulting unfavorable consequences, for example, mass and cost budget.

An approach widely used in currents CMFs is to analyse the impact of the medium properties and the complete environment on the measurement effect and correct it instantaneously.

Such a technology for CMFs is known as online-diagnosis or adaptive/smart sensor electronics. The approach provides further possibilities to deal with the deficit of a given CMF, but it also follows a trend in mechatronics, which consists in combination of appropriate mechanical designs with intelligent signal processing algorithms.

Currently used in CMFs are different model-based signal processing technologies, which work with simplified mechanical models of the dynamic system. For example, characteristic numbers or coupling constants derived from an underlying model can be detected. The actual measured values are corrected with appropriate algorithms to compensate the assumed effects. Such an approach can be an approximation of the complexity of the real device with the resulting limitation for the achievable measurement accuracy.

### SUMMARY

Signal processing method is disclosed for a Coriolis mass flow meter with one or more measuring tubes and meter electronics, comprising: determining relevant modal properties of the flow meter during a measurement process; and adaptively correcting a current measurement result of the flow meter with the relevant modal properties of the flow meter obtained during the measurement process.

A Coriolis mass flow meter is disclosed, comprising: one or more measuring tubes; meter electronics which are configured to perform a signal processing method, the signal processing method comprising: determining relevant modal properties of the flow meter during a measurement process; and adaptively correcting a current measurement result of the flow meter with the relevant modal properties of the flow meter obtained during the measurement process.

### BRIEF DESCRIPTION OF THE DISCLOSURE

The disclosure will be described in greater detail by description of exemplary embodiments with reference to the accompanying drawings, wherein

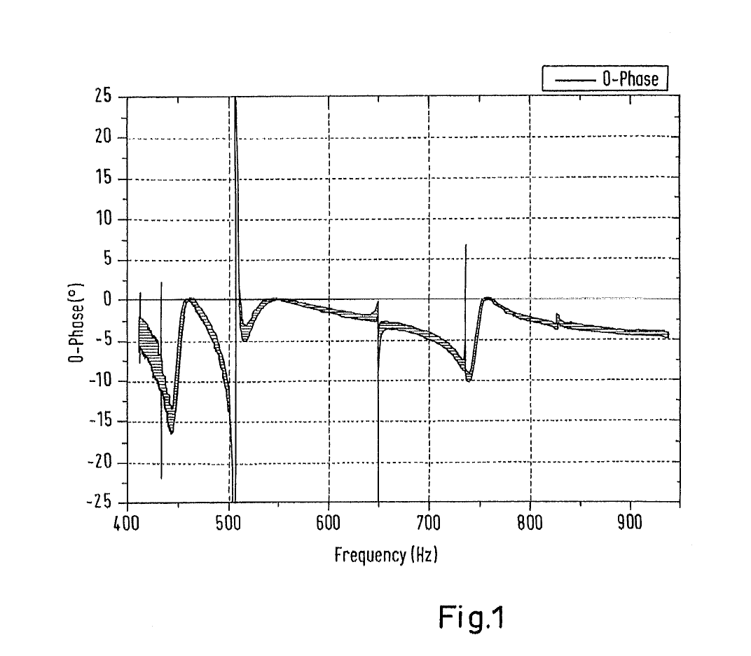

FIG. 1 shows a measurement of 0-phase vs. frequency, in correlation with Eigen-frequencies from finite element analysis;

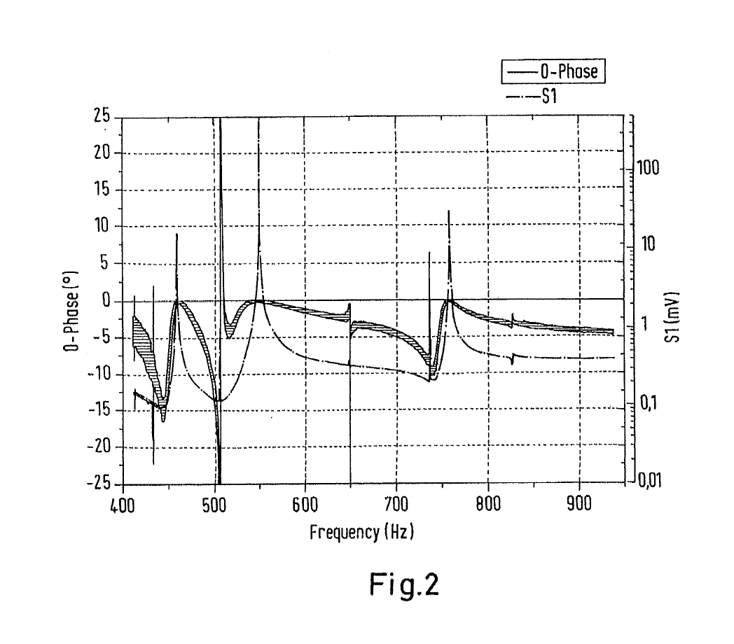

FIG. 2 shows the measurement as in FIG. 1, with sensor amplitude on a logarithmic scale shown on the right side;

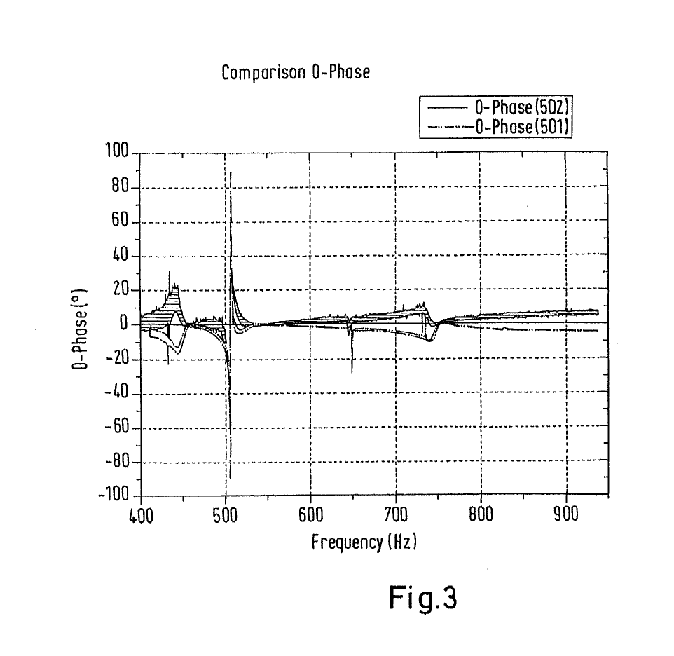

FIG. 3 shows the measurement of 0-phase vs. frequency in comparison of two demonstrators;

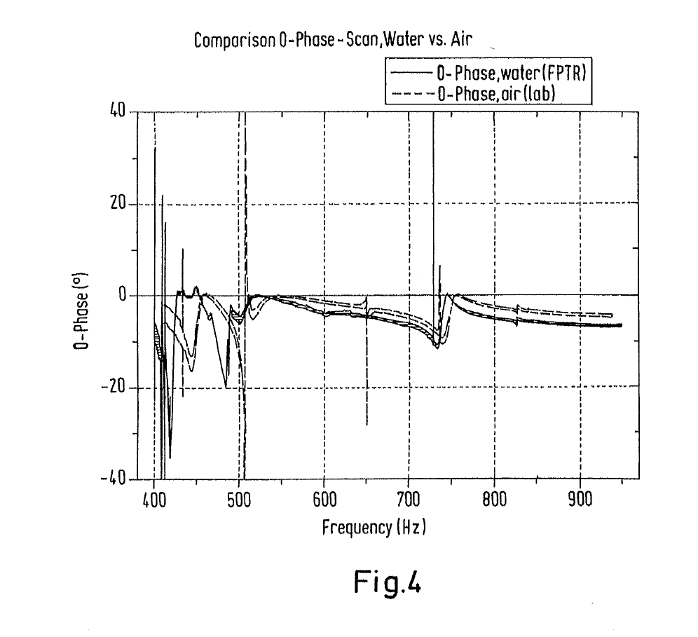

FIG. 4 shows the measurement of 0-phase vs. frequency and the influence of density influence and boundary conditions for the same demonstrator as referred to in FIG. 3; and

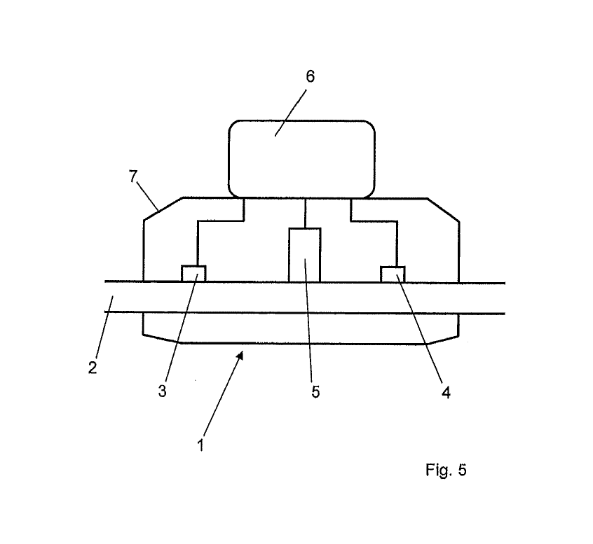

FIG. 5 shows a scheme of a Coriolis mass Flow meter according to an exemplary embodiment.

### DETAILED DESCRIPTION

According to the disclosure, the accuracy and robustness of the measurement process performed in the CMF can be enhanced by determining directly the relevant modal properties of the device during the measurement process and correcting the current measurement results adaptively with this values.

In accordance with an exemplary embodiment, a CMF according to the disclosure has one or more measuring tubes and a meter electronics which is configured to perform a signal processing method, and the meter electronics is configured to determine directly the relevant modal properties of the device during the measurement process and to correct the current measurement results adaptively with this values, so that the accuracy and robustness of the measurement process performed by the Coriolis mass flow meter is enhanced.

In accordance with an exemplary embodiment, the CMF with the measurement process according to the disclosure does not rely on simplified models, but uses the complete information which is available from the modal spectrum of the device.

According to an exemplary embodiment of the disclosure, the relevant modal properties of the device can be directly determined by additionally exciting several different frequencies at least temporarily and evaluating the respective frequency responses.

According to an exemplary embodiment of the disclosure, the correction can be based on a comparison of the relevant modal properties of the current state with an initial or several different reference states, with the respective modal properties being stored in the transmitter (e.g., memory).

According to an exemplary embodiment of the disclosure, the determined modal properties can be used to detect secondary measurement quantities, for example, a thermal state of the sensor or viscosity of the measured medium.

According to an exemplary embodiment of the disclosure, the meter electronics can be configured to determine the relevant modal properties of the device directly by additionally exciting several different frequencies at least temporarily and evaluating the respective frequency responses.

According to an exemplary embodiment of the disclosure, the meter electronics can be configured to base the correction on a comparison of the relevant modal properties of the current state with an initial or several different reference states, with the respective modal properties being stored in the meter electronics (e.g., memory).

According to an exemplary embodiment of the disclosure, the meter electronics can be configured to use the determined modal properties to detect secondary measurement quantities, for example, a thermal state of the sensor or viscosity of the measured medium.

FIG. 5 shows an exemplary embodiment of a Coriolis Mass Flow Meter, also called CMF. In accordance with an exemplary embodiment, the CMF 1 has one single straight measuring tube 2, through which the medium to be measured flows. In accordance with an alternative exemplary embodiment, the measuring tube 2 can be a double-tube CMF, with a straight or a bent tube in accordance with known geometrical structures. On the tube 2, there is mounted, in a known manner, an actuator 5 which induces a vibrational force on to the measuring tube 2. Two displacement sensors 3 and 4 are mounted, in a known manner, upstream and downstream respectively of the actuator 5. The tube 2, sensors 3 and 4 and the actuator can be covered by a protective housing 7. Fixed to the housing can be meter electronics 6, for example, a transducer. The meter electronics 6 can be functionally connected to the actuator 5 and the sensors 3, 4. The meter electronics 6 can be configured to perform a signal processing method, and the meter electronics 6 can be configured to determine directly the relevant modal properties of the CMF 1 during the measurement process and to correct the current measurement results adaptively with this values, so that the accuracy and robustness of the measurement process performed by the Coriolis mass flow meter 1 can be enhanced.

In accordance with an exemplary embodiment, the dynamic response of a linear discrete multi-body system can be determined by its modal spectrum. For example, any real mechanical system which can be approximated by such a system, the exactitude follows from the achieved accuracy of the representation. For example, due to the very small deformation of Coriolis mass flow meters (or CMFs), the achieved accuracy can be represented with any necessary accuracy by discrete linear systems, for example, finite element formulation, which can, for example, include the actual measuring effect. The Coriolis forces induced by mass flow combined with appropriate actuation can lead to the case of a complex modal spectrum, for example, a set of eigenmodes can be described by respective eigenfrequencies and magnitudes at all positions of the structure, but also by specific phase angles at different points of the device. In addition, this can also be applied for a complex modal spectrum.

As a CMF measures the dynamic effect of mass flow, the phase difference between two sensor positions induced by Coriolis effect, or often in practice more complicate so called 0-phase, which is the phase signal without corresponding mass flow, it is understandable that the measurement effect is also completely determined by the modal spectrum of the complete system, including, for example, media and interaction with the environment.

In accordance with an exemplary embodiment, for a correctly manufactured, sensible designed and mounted CMF to detect changes in the modal spectrum can be used to correct unwanted influences from media or environment effect on the measurement. The specifications noted here imply that the CMF can be represented with a linear model, which can be as complicated as necessary, for example, a finite element model comprising millions of degree of freedoms, and that the mounting conditions do not dominate the device functionality. All off these specifications can be standard for the usage of CMFs.

Intrinsic generation of 0-phase by CMF device tolerances can serve as a first example for the application of the disclosed adaptive signal processing technology. In accordance with an exemplary embodiment, intrinsic refers to manufacturing tolerances, which cannot be avoided to a certain degree in any real system, for example, an ideal CMF shouldn't exhibit any 0-phase at all.

In accordance with an exemplary embodiment, to illustrate this, in FIG. 1 frequency response of a 0-phase measurement for a given CMF device is shown. For investigation purpose and to exclude other effects as far as possible, the measurement was conducted in, ideally symmetric, free boundary conditions and without any mass flow, the device was filled with air.

Additionally, eigenfrequency results from finite elements analysis of the design were plotted in the same graph. The terminology used here gives a classification with respect to the two sensors used in the device: the z-axis is parallel to the sensor axis, which is typically also the actuator axis, hence the modes designated as z-antisymmetric are modes with major displacement in direction of the z-axis and same magnitude in antiphase with respect to the two sensors. The z-symmetric modes show also major displacement in this direction, with same magnitude but without any phase-shift. The operation mode is part of this class. All other modes in this class are marked differently here. Finally, all other modes exhibiting displacement in antiphase at the sensor positions, but not dominantly in direction of z-axis, are also marked.

The correlation of the phenomena visible in measurement data and simulation results can be explained by the fact, that a simultaneous response of symmetric and anti-symmetric modes leads to a non-vanishing 0-phase measurement even for zero mass flow, hence no Coriolis forces are present. As it can be observed, z-antisymmetric modes can lead to increased 0-phase at their resonance frequency, with sign change due to phase change while excitation frequency is passing through resonance frequency. Z-symmetric modes can lead to asymptotic behaviour of the 0-phase towards zero magnitude due to amplification of symmetric part. In accordance with an exemplary embodiment, the latter observation is also illustrated by FIG. 2, where in addition to the data already shown in FIG. 1 also the magnitude of one of the two sensors is plotted.

In accordance with an exemplary embodiment, for different devices of the same design slightly different eigenfrequencies in the order of some few Hertz can be measured, so the consistency of measurement and simulation data may be characterized as rather good.

For example, to give a further illustration of the phenomena described above as intrinsic generation of 0-phase, in FIG. 3 measurement data for two different devices, but with the same design is presented. In accordance with an exemplary embodiment, the same phenomena correlated to the modal spectrum as shown in FIG. 1 are visible for both devices, even with about the same magnitude. For example, both devices have low arbitrary tolerances of the same order, and the sign may be different. In the two measurements shown here, the same sign of 0-phase is found around the first z-antisymmetric mode for the two compared devices.

The adaptive signal processing technology described in this disclosure can rely on the dynamic response of a mechanical system, which can be determined by the knowledge about the modal spectrum and the acting forces.

For example, the 0-phase at operational frequency is of interest, which is nothing other than the dynamic response of the system for a given excitation. To be able to determine the intrinsic generated 0-phase of the device, the knowledge of the modal properties of the relevant eigenmodes, for example, respective natural frequency, modal damping and eigenshape as seen from the two sensors, combined with the modal projection of the excitation force can be sufficient.

For an exemplary embodiment, the accuracy can depend on the exactitude with which the information from the modal spectrum of the device can be obtained with reasonable effort in normal operating conditions.

For example, an approach may not be able to measure the complete 0-phase response, however, a small number of measurement points may be sufficient to determine the necessary properties of the relevant part of the modal spectrum. For example, in the measurement shown in FIG. 1, the effect of five eigenmodes is observable. In accordance with an exemplary embodiment, these modes may be characterized by, for example, 15 different parameters, respectively eigenfrequency, modal damping and excitation, which can be determined with high accuracy from about 50-100 measurement points. As also the dynamic response of the CMF at frequencies away from the operational frequency can be important, these measurements can be done during standard operation of the device with appropriate combination of actuation signal and respective frequency filtering of response. In accordance with an exemplary embodiment, as the Coriolis forces induced by the mass flow can be several orders smaller than the actuation force used, the magnitude of the additional excitation may be chosen suitably small and will therefore not interact with the standard operation of the CMF.

In accordance with an exemplary embodiment, choosing the right characteristic measurement points can help to increase the exactitude of the determinations of the modal parameters, and also exclude for example measurement noise. For example, this may be done by using an underlying analytical model. In accordance with an exemplary embodiment, the appropriate analytical model can be straightforward from the correlation of the phenomena visible in measurement data and simulation results. For example, this model is based on the actual measurement results, and incorporates no simplifications, but can rather be considered as some smoothing or fitting of the measurement.

In accordance with another exemplary embodiment, an empiric approach based on evaluation of the characteristic properties of a specific design and use of appropriate algorithms may be used as an alternative.

In most applications of CMFs, it is not of interest to determine an absolute value of the 0-phase, which can be corrected, for example, after production or installation of the device in the site, but detection of the change of the 0-phase during operation with the resulting loss of measurement accuracy can be important.

An example of such a situation is given in FIG. 4. As shown in FIG. 4, in addition to the measurement already shown in FIG. 1, a second measurement is shown with the same device but now with water as media and mounted in deliberately unfavorable chosen conditions. Although the influence from the dynamic response of the environment is visible, appropriate algorithms provided with the information from operation in different conditions can be used to be able to sensibly mitigate the effect. Otherwise such measurement conditions could result in complete malfunction for a state of the art CMF.

For practical implementations of the disclosure, a reasonably accurate diagnosis of this change can be sufficient and can be used as valuable and affordable mitigation. For example, a possible loss of accuracy can be a result of the exactitude of the information obtained from the measurement and the signal processing algorithms implemented. In accordance with an exemplary embodiment, these factors can depend on, for example, commercial considerations.

In accordance with an exemplary embodiment, a combination of the two methods described above can give an efficient method to deal with this general CMF issue, which can include determining relevant modal properties with characteristic measurement points and use of an underlying analytical model, combined with an empirical approach using suitable algorithms appropriate for the specific design and it's characteristic behaviour.

In accordance with an exemplary embodiment, to gather the information for these algorithms, a sort of calibration process can be implemented into the manufacturing process. For example, for each specific device, with respective unique combinations of tolerances, to train it in different situations, such as mounting conditions, media and environment properties such as fluid density and ambient temperature. In accordance with an exemplary embodiment, with this process, each device can be individually prepared to perform with highest possible accuracy under all possible conditions. In accordance with an exemplary, although the process can be time-consuming, since the measurement and evaluation facilities can be on board of each device, the cost impact of each device should not be considerable.

For example, the accuracy of the density measurement, which is incorporated in each CMF to determine volume flow from mass volume measurement, can be substantially increased by using the frequency change induced by density of media by one eigenmode, the operational mode, as it is the case in commercially available Coriolis mass flow meters, and using the frequency change of a second eigenmode. In accordance with an exemplary embodiment, the concept can be extended to determine the density from the complete modal spectrum, whereby the relevant part of the modal spectrum is the part that depends on media density change, which can result in higher accuracy.

In addition, two further examples are given now below. For example, first is viscosity measurement: for CMF designs, in which there is no single mode, which depends on viscosity, it should nevertheless be possible to determine the latter with high accuracy by using characteristic changes of relevant modes, for example, quality factor and frequency change due to dissipation and rotational inertia effects. Temperature measurement may serve as second example: by using characteristic information about the change of the modal spectrum with temperature for a specific design, evaluating these changes with appropriate algorithms in a modal spectrum of a given CMF in operation should yield the current operational temperature. In accordance with another exemplary embodiment, influences from temperature and externally induced stress can also be separated with this approach.

In accordance with an exemplary embodiment, the method and processes as disclosed herein can be extended to all physical quantities interacting with the modal spectrum of the device.

In accordance with an exemplary embodiment, the process can enhance performance criteria of for example a CMF in parallel with the same hardware. For example, retrieving once the relevant change of the modal spectrum depending on environmental conditions can be exploited in parallel to increase 0-phase stability with temperature and density accuracy measurement. For example, one can also determine viscosity of the medium using the same measurement and hardware with suitable algorithms using Digital Signal Processors (DSP)(e.g., processor).

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. Signal processing method for a Coriolis mass flow meter with one or more measuring tubes and meter electronics, comprising:
determining relevant modal properties of the flow meter during a measurement process; and
adaptively correcting a current measurement result of the flow meter with the relevant modal properties of the flow meter obtained during the measurement process.

2. Signal processing method according to claim 1, comprising:
determining the relevant modal properties of the flow meter by additionally exciting several different frequencies at least temporarily; and
evaluating respective frequency responses.

3. Signal processing method according to claim 1, wherein correcting of the current measurement result comprises:
comparing the relevant modal properties of a current state of the flow meter with an initial reference state of the flow meter.

4. Signal processing method according to claim 3, comprising:
storing the initial reference state of the flow meter in the meter electronics.

5. Signal processing method according to claim 1, wherein correcting of the current measurement result comprises:
comparing the relevant modal properties of a current state of the flow meter with several different reference states of the flow meter.

6. Signal processing method according to claim 5, comprising:
storing the several different reference states of the flow meter in the meter electronics.

7. Signal processing method according to claim 1, comprising:
detecting secondary measurement quantities using the determined modal properties.

8. Signal processing method according to claim 7, wherein the secondary measurement quantities include a thermal state of a sensor and/or a viscosity of a measured medium.

9. A Coriolis mass flow meter, comprising:
one or more measuring tubes;
meter electronics which are configured to perform a signal processing method, the signal processing method comprising:
determining relevant modal properties of the flow meter during a measurement process; and
adaptively correcting a current measurement result of the flow meter with the relevant modal properties of the flow meter obtained during the measurement process.

10. The Coriolis mass flow meter according to claim 9, wherein the meter electronics is configured to determine the relevant modal properties of the flow meter by evaluating respective frequency responses.

11. The Coriolis mass flow meter according to claim 9, wherein the meter electronics is configured to correct the current measurement result based on a comparison of the relevant modal properties of a current state of the flow meter with an initial reference state of the flow meter.

12. The Coriolis mass flow meter according to claim 11, wherein the meter electronics is configured to store the initial reference state of the flow meter.

13. The Coriolis mass flow meter according to claim 9, wherein the meter electronics is configured to correct the current measurement result based on a comparison of the relevant modal properties of a current state of the flow meter with several different reference states of the flow meter.

14. The Coriolis mass flow meter according to claim 13, wherein the meter electronics is configured to store the several different reference states of the flow meter.

15. The Coriolis mass flow meter according to claim 9, wherein the meter electronics is configured to detect secondary measurement quantities using the determined modal properties.

16. The Coriolis mass flow meter according to claim 15, wherein the secondary measurement quantities include a thermal state of a sensor.

17. The Coriolis mass flow meter according to claim 15, wherein the secondary measurement quantities include a viscosity of a measured medium.

18. The Coriolis mass flow meter according to claim 9, wherein the meter electronics comprises:
a digital signal processor.

19. The Coriolis mass flow meter according to claim 9, comprising:
an upstream displacement sensor and a downstream displacement sensor; and
an actuator, which is configured to introduce a vibrational force on to the one or more measuring tubes, and wherein the upstream displacement sensor, the downstream displacement sensor, and the actuator are functionally connected to the meter electronics.

20. The Coriolis mass flow meter according to claim 19, comprising:
a protective housing configured to cover the one or more tubes, the sensors and the actuator.
